(19) United States
(12) Patent Application Publication
(10) Pub. No.: US 2009/0242153 A1
(43) Pub. Date: Oct. 1, 2009

(54) PROCESS FOR MANUFACTURING A FIBROUS PLY COMPRISING AN ELEMENT OF A GIVEN THICKNESS AND FORMING FABRIC FOR PRODUCING THE FIBROUS PLY

(75) Inventors: Michel Camus, Rives Sur Fure (FR); Pierre Doublet, Saint-Brice (FR)

Correspondence Address: OLIFF & BERRIDGE, PLC, P.O. BOX 320850, ALEXANDRIA, VA, 22320-4850, US

(73) Assignee: ARJOWIGGINS SECURITY, ISSY LES MOULINEAUX (FR)

(21) Appl. No.: 12/373,830

(22) PCT Filed: Aug. 6, 2007
(86) PCT No.: PCT/FR07/51784

§ 371 Date: Mar. 23, 2009

(30) Foreign Application Priority Data
Aug. 8, 2006 (FR) 0607238

(51) Int. Cl. D21H 21/40; B32B 5/26; B32B 3/00; B32B 3/10; D03D 9/00; B05D 3/00; B29C 59/00; D21H 21/00; D06C 13/00

(52) U.S. Cl. 162/110; 442/239; 428/172; 428/138; 442/1; 427/331; 264/293; 162/158; 162/140; 26/7

(57) ABSTRACT

A wet process for manufacturing a fibrous ply on a forming fabric of a paper machine, including a stack of fabrics, the stack of fabrics having a surface fabric and at least one under-fabric, these being superposed, the fibrous ply having at least one element of a given thickness, wherein it includes the following step: formation of the ply by the dewatering of an aqueous fiber-based suspension on the forming fabric, the stack of fabrics of which includes a reduced dewatering region compared with the first under-fabric, in at least one under-fabric and/or beneath the surface fabric, the reduced dewatering region being in correspondence with the position that the element will have.

The invention relates to a method for manufacturing a fibrous ply, particularly a paper, used notably for manufacturing security documents such as banknotes, checks, travel tickets, entry tickets to cultural or sports events. It also relates to the fabric of the forming fabric and to the method of manufacturing the fabric.

In this description, the term “paper” means any sheet obtained by a wet process from a suspension of natural cellulose fibers and/or of mineral or organic fibers other than cellulose, possibly synthetic fibers, which may contain various fillers and various additives commonly employed in papermaking.

In the security documents industry, use is made of numerous security elements that cause increases in the thickness of the sheet containing them.

For example, in order to authenticate a paper document, use is made of a watermark. This watermark may be a watermark of the “dark” type. A watermark such as this is obtained at the time of manufacture of the fibrous sheet using round shapes comprising a countersunk etching of the watermark that is to be reproduced. This then yields a sheet with a watermark that appears dark when held up to the light, the dark zones being due to a build-up of fibers in the countersunk parts of the etching as the sheet is being formed. Thus, the fiber density and therefore the thickness of the sheet are greater in these zones than in the remainder of the sheet.

A watermark such as this therefore exhibits increases in thickness. On average, for finished security sheets such as banknotes, these increases in thickness measure 20 μm and may measure as much as 35 μm in the case of the darkest of watermarks.

Another widely used security element is the security thread. A security thread is in the form of a continuous long strip incorporated into the suspension of fibers during the manufacture of the sheet, or alternatively between two fibrous layers. In some applications, the thread can be seen through openings (known as “windows”) made in one or both sides of the sheet.

Application EP 0059056 describes how to incorporate a thread into a single ply of fibers at the time the ply is being formed, and which is visible through windows in one of its sides.

Security threads and strips have a width generally ranging between 1 and 30 mm, a thickness ranging between 10 and 50 μm, and a position from one edge to the opposite edge, across an entire length, an entire width or an entire height of the sheet and therefore do not occupy the entire surface area of the sheet. As a result, they too cause an increase in thickness by comparison with the rest of the sheet.

When sheets containing security elements that create additional thickness are stacked, the parts that contain these security elements are superposed and create raised zones in the stack. This can lead to problems in sheet processing, for example in cutting or printing, and there is a risk that the sheets will slip from the stack, notably when they are being picked up automatically. In machines for sorting documents such as banknotes, problems resulting from the non-flatness of the sheets and likewise when storing them in bundles, may be encountered.

To solve these problems, those skilled in the art may position wedges between the sheets. It is also possible to invert the stacks of a few sheets in order to alternate the locations of the additional thicknesses of the stacks. This then requires manipulation of the sheets, which is necessary to allow the sheets to be processed correctly, but which leads to additional and painstaking work which hampers rapid processing of the sheets, particularly at the time of printing.

Those skilled in the art use other solutions. For example, it is possible to pass watermarked sheets between rolls, but this makes the watermarks brighter and is detrimental to the security of the sheet. In the case of sheets containing security threads, it is common practice for the positions of the security threads to be offset slightly from one sheet to another (to traverse them), for example over a sequence of four sheets, in order to limit the extent to which the threads become superposed when the sheets are stacked.

Application EP 0773220 discloses a fibrous security sheet comprising a watermark and at least one security strip positioned in such a way as to compensate the additional thicknesses of one another, and so that the sheet exhibits better flatness.

However, a sheet such as this is still not flat enough and the security elements such as threads or strips or watermarks still stand proud of the surface of the vellum part of the sheet. Further, the solution proposed by that application entails very specific relative positioning of the watermark and of the strip, making placement thereof complicated and limiting the number of layouts.

At the present time, there is not therefore any satisfactory solution for obtaining sheets that are flat and contain security elements such as watermarks, security threads or other elements that lead to the creation of additional thickness at the surface of the sheet with respect to the level of the vellum part.

It is therefore an object of the present invention to propose a method of manufacturing a fibrous ply comprising such security elements, the surface of which does not exhibit any appreciable increases in thickness.

The Applicant Company has found that this object can be achieved using a method for using a wet process to manufacture a fibrous ply on a forming fabric of a papermaking machine comprising a stack of fabrics, said stack of fabrics comprising a surface fabric and at least one under-fabric, these being superposed, said fibrous ply comprising at least one element of a given thickness, characterized in that it comprises the following step:
forming said ply by dewatering a fiber-based aqueous suspension on said forming fabric, the stack of fabrics of which includes a region of reduced dewatering with respect to the dewatering of the first under-fabric, in at least one under-fabric and/or under the surface fabric, said region of reduced dewatering being in register with the position that said element will occupy.

In general, a “forming fabric” of a papermaking machine is made of a stack of several woven metal or plastic wire fabrics for draining or dewatering the suspension of fibers that is deposited thereon in order to form a fibrous ply, so as notably to have a fabric that is rigid enough to withstand the papermaking process.

The term “surface fabric” is used here to denote the outermost fabric of the stack of fabrics, on which the fibrous suspension is dewatered to form a fibrous ply, and which fabric may be embossed in order to create reliefs such as watermarks within said ply.

The term “under-fabric” is used to denote any fabric in the stack of fabrics other than the surface fabric. Further, the under-fabric situated directly beneath the surface fabric is termed the “first under-fabric” and the under-fabric situated directly beneath the first under-fabric is termed the “second under-fabric”.

Usually, the linear wire density is uniform for one particular fabric or under-fabric and this decreases from the surface fabric to the last under-fabric, it being known that the lower the wire density, the higher the dewatering rate.

The expression “region of reduced dewatering” with respect to the first under-fabric therefore means a region in which the dewatering rate is slowed by comparison with that of the first under-fabric.

For preference, the under-fabric equipped with at least one zone of reduced dewatering is the first under-fabric, positioned directly under the surface fabric.

According to the method of the invention, in the zone of the surface fabric that is situated above the region of reduced dewatering created in one of the under-fabrics, the amount of fibers deposited is lower than the amount of fibers deposited on the remainder of the surface fabric. As a result, the fiber thickness here will be lower than in the remainder of the fibrous ply, thus creating a depression. The thickness of the security element positioned at the same point will then be compensated by the drop in the amount of fibers deposited. As a result, the fibrous ply will have no appreciable increase in thickness at its surface.

One advantage of the method according to the invention is that it makes it possible to obtain a fibrous ply that has no appreciable increase in thickness at its surface without the need to modify the surface fabric, thus in particular meaning that the embossed surface fabrics currently in use, for example for manufacturing watermarks, need not be changed.

Another advantage of the method according to the invention is that it modifies very little, if at all, the structure of the security element of which the thickness is compensated. Part of the thickness of the element that used to generate an increase in thickness now no longer lies at the surface of the fibrous ply, the element being “nested” into the depression created in the ply.

For preference, the region of reduced dewatering has a dewatering rate equal to or lower than that of the surface fabric.

According to one embodiment of the invention, said element of a given thickness is formed in or incorporated into the wet ply while said ply is being formed on said forming fabric. In particular, this may be a watermark or a security thread.

According to another embodiment of the invention, said element of a given thickness is attached to said ply after said ply has been formed. In particular, this may be a flat element in strip form (a foil) or a flat element of small size (a patch), attached to the surface of the ply, it being possible for the element to be attached once the fibrous ply has dried, away from the papermaking machine production line.

For preference, the fiber-based suspension comprises cellulose fibers, particularly cotton fibers and/or organic synthetic fibers and/or mineral fibers.

According to a preferred embodiment of the invention, the stack of fabrics is the forming fabric of the cylinder of a cylinder mold of a papermaking machine. This embodiment is particularly advantageous when the security element of which the additional thickness is compensated for is a watermark or an element such as a security thread visible through a window.

According to another embodiment of the invention, the stack of fabrics is the forming fabric of a fourdrinier of a papermaking machine.

For preference, the region of reduced dewatering has dimensions equal to or appreciably greater than those of the corresponding security element of given thickness. In this way, a depressed zone set back from the surface of the ply is created, the security element, in the case of a watermark, generating a relief on the surface of this depression.

The security element is of a thickness less than that of the fibrous ply, and preferably of between 10 μm and 60 μm and in particular of between 20 and 40 μm.

For preference, the fibrous ply has a thickness of between 80 and 120 μm.

According to one embodiment of the invention, the fabric and the under-fabrics consist of interlaced wires forming meshes.

According to one preferred embodiment of the invention, the region of reduced dewatering of the under-fabric has a wire density equal to or greater than that of the surface fabric. For example, the density of the region of reduced dewatering is 12 wires/cm (30 mesh), whereas the surface fabric density is 8 wires/cm (20 mesh), for the same wire diameter. A person skilled in the art will know how to adapt the wire density that is to be used in the zone of reduced dewatering to suit the thickness of security element that requires compensation.

For preference, the compensation for the thickness of said element at the surface of the sheet thanks to the presence of the region of reduced dewatering is such that the top of the highest section of the relief generated by the security element lies at the same level as the remainder of the surface of the vellum part of the fibrous ply. This then yields a fibrous ply that has a flat surface over its entirety, on both sides.

According to one embodiment of the invention, the surface fabric has embossings, particularly countersunk embossings, facing the region of reduced dewatering.

For example, the surface fabric has embossings to create watermarks. It may also be equipped with parts that obstruct the dewatering, of the galvano type, to create openings in, and which may or may not open to the surface(s) of, the fibrous ply.

In particular, when the surface fabric is embossed, for example with countersunk embossings to create a watermark in the fibrous ply, the first and/or the second under-fabric have an opening facing the embossed zones of the surface fabric. This layout makes it possible to prevent the embossed zones of the surface fabric from being pressed against the first or the second under-fabric and makes it possible to protect the watermark in the fibrous ply.

According to one embodiment of the invention, the first under-fabric comprises an opening facing the position of said element of given thickness, and a perforated piece of dimensions approximately equal to those of said opening and allowing reduced dewatering with respect to said under-fabric is attached under the surface fabric, at a position corresponding to said element.

According to another embodiment of the invention, the first under-fabric comprises an opening facing the position of said element of given thickness, and a perforated piece of dimensions approximately equal to those of said opening and allowing reduced dewatering with respect to said under-fabric is fixed to the first under-fabric, in this opening, at a position corresponding to said element.

For preference, said perforated piece of dimensions approximately equal to those of said opening is embossed in exactly the same way as the embossings in said surface fabric.

According to one embodiment of the invention, at least one region of reduced dewatering is in discrete form. This embodiment is particularly advantageous when the element of which the thickness is being compensated is a continuous strip partially incorporated into the fibrous ply and lying flush in the openings at the surface of said fibrous ply, or in the case of watermarks, or alternatively in the case of a flat element that is small in size by comparison with the dimensions of the ply (a patch).

According to another embodiment of the invention, at least one under-fabric comprises at least one region of reduced dewatering having the shape of a continuous zone of given width extending along the entire length or along the entire width of said forming fabric. This embodiment is particularly advantageous when the element of which the additional thickness is being compensated is a continuous strip at least partially incorporated into the fibrous ply, such as a security thread that may or may not be visible in windows.

According to one embodiment of the invention, the method comprises a step whereby said continuous strip is incorporated into the zone facing the region of reduced dewatering while said fibrous ply is being formed on the forming fabric. For example, the strip introduced is a security strip or thread with a width of between 1 and 30 mm and, in particular, of between 1 and 10 mm.

According to another embodiment of the invention, the fibrous ply comprises a dark or countersunk watermark, said watermark being formed by embossings comprising countersunk embossed portions in the surface fabric, said embossings facing regions of reduced dewatering.

According to one embodiment of the invention, said region of reduced dewatering comprises several zones that have different dewatering rates.

In particular, said region of reduced dewatering comprises a central zone surrounded by at least two edge zones, said central zone and edge zones having different dewatering rates. For preference, the central zone has a dewatering rate lower than the dewatering rates of the edge zones. This embodiment may prove advantageous when the zone of reduced dewatering is large.

It is also possible to envision for the region of reduced dewatering to be divided into several zones, the dewatering rate increasing as said zones near the center of the region, thus creating a “degradation” of dewatering rates.

Another subject of the present invention is a forming fabric of a papermaking machine comprising a stack of fabrics comprising a surface fabric and at least one under-fabric, used when forming a fibrous ply, which is characterized in that at least one region of reduced dewatering with respect to the first under-fabric is situated in at least one under-fabric and/or attached under the surface fabric.

For preference, the region of dewatering has a reduced dewatering rate equal to or lower than the dewatering rate of the surface fabric.

For preference, the first under-fabric comprises a region of reduced dewatering.

For preference, all the regions of reduced dewatering are on the first under-fabric.

According to one embodiment of the invention, the surface fabric comprises embossings, particularly countersunk embossings, situated in particular facing the zone of reduced dewatering.

For preference, the region of reduced dewatering has embossings that are identical to the embossings of the surface fabric and facing the latter.

According to one embodiment, the first under-fabric comprises an opening, and a perforated piece of dimensions approximately equal to those of said opening and which allow reduced dewatering with respect to said under-fabric, is attached under the surface fabric.

According to another embodiment, the first under-fabric comprises a perforated piece that allows reduced dewatering with respect to said under-fabric.

According to one embodiment of the invention, the surface fabric and the under-fabrics consist of interlaced wires forming meshes.

For preference, the region of reduced dewatering has a linear wire density equal to or greater than the linear wire density of the surface fabric.

According to one embodiment of the invention, said region of reduced dewatering comprises several zones that have different dewatering rates.

In particular, said region of reduced dewatering comprises a central zone surrounded by at least two edge zones, said central zone and edge zones having different dewatering rates. For preference, the central zone has a dewatering rate lower than the dewatering rates of the edge zones.

Another subject of the invention is a method of manufacturing a fabric as described hereinabove, and which is characterized in that a region of reduced dewatering is created by using a portion of a fabric or a perforated piece that allows the dewatering to be reduced with respect to the first under-fabric.

According to one embodiment of the invention, the region of reduced dewatering is created by using a portion of a fabric that has a higher wire density than that of the first under-fabric, in particular, equal to or higher than that of the surface fabric.

According to one embodiment of the invention, the region of reduced dewatering is situated in an under-fabric and is obtained by cutting away a fragment of said under-fabric and then in its place attaching an approximately same-sized fragment of a fabric that has a wire density higher than the remainder of the under-fabric.

In particular, said portion of fabric has a linear wire density equal to or greater than that of the surface fabric.

According to another embodiment, said region of reduced dewatering is created by attaching a portion of a fabric directly under the surface fabric.

According to another embodiment of the invention, said region of reduced dewatering of the under-fabric is obtained by cutting away a fragment of said under-fabric and in its place attaching a perforated piece that allows reduced dewatering with respect to said under-fabric.

According to another embodiment, said region of reduced dewatering is created by attaching a perforated piece directly under the surface fabric.

According to one embodiment of the invention, said perforated piece is made of metal or of plastic.

According to another embodiment, said perforated piece is obtained by depositing a photosensitive resin on the surface fabric and insolating said resin using a perforated mask, the insolated portions of said resin being eliminated. This may, for example, be an organic polymer resin sensitive to ultraviolet radiation, the UV radiation causing the insolated zones to go into solution such that they can then be eliminated.

According to another embodiment, said perforated piece is obtained by depositing a photosensitive resin on the surface fabric and insolating said resin using a perforated mask, the non-insolated portions of said resin being eliminated. This may, for example, be a polymerizable organic resin sensitive to ultraviolet radiation, the UV radiation leading to polymerization and therefore good strength of the insolated zones, unlike the non-insolated zones which can then be eliminated.

According to one embodiment of the invention, the surface fabric is embossed and said bit of fabric or said perforated piece is embossed in exactly the same way as the embossings of the surface fabric.

Another subject of the invention is a security sheet containing at least one fibrous ply obtained by one of the manufacturing methods described hereinabove and/or using a fabric described hereinabove.

In particular, a subject of the invention is a sheet comprising at least one watermark and/or at least one security thread, more specifically a security thread visible in windows, notably in accordance with patent application EP 0059056.

A final subject of the invention is a security document obtained from the security sheet described hereinabove. In particular, a subject of the invention is a means of payment such as a banknote or a check, an identity document such as an identity card or a passport, a travel ticket, an entry ticket to a cultural or sports event.

The invention will now be described in greater detail with the aid of the attached figures in which:

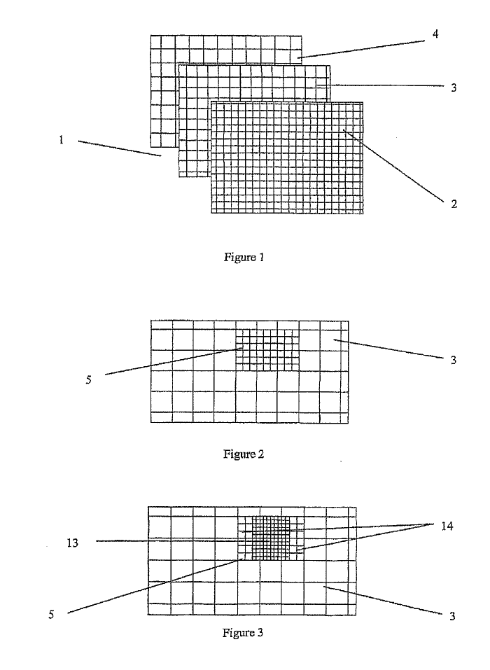

FIG. 1 depicts a portion of a stack of fabrics of a forming fabric according to the invention,

FIG. 2 depicts an under-fabric of a fabric according to the invention, said under-fabric being equipped with a region of reduced dewatering,

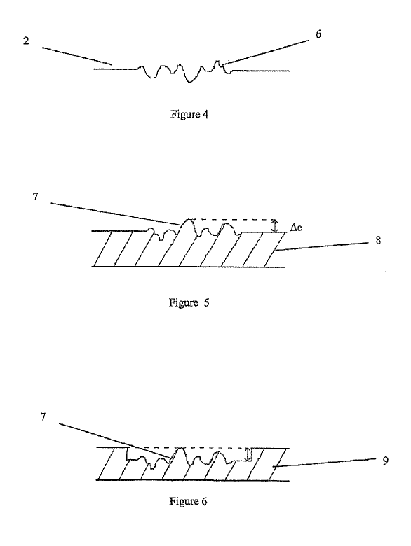

FIG. 3 depicts an under-fabric of a fabric according to another embodiment of the invention, said under-fabric being equipped with a zone of reduced dewatering divided into several zones with different dewatering rates,

FIG. 4 depicts part of a surface fabric equipped with embossing intended to create a countersunk watermark in a fibrous ply,

FIG. 5 depicts a view in cross section of a fibrous ply equipped with a watermark manufactured, using the surface fabric of FIG. 4, according to a “conventional” method of the prior art,

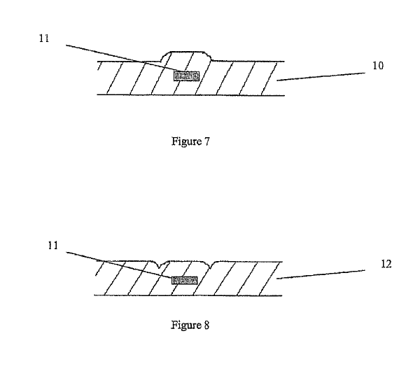

FIG. 6 depicts a view in cross section of a fibrous ply equipped with a watermark manufactured, using the surface fabric of FIG. 4, according to the method of the invention,

FIG. 7 depicts a view in cross section of a fibrous ply equipped with a security thread, manufactured using a “conventional” method of the prior art,

FIG. 8 depicts a view in cross section of a fibrous ply equipped with a security thread, manufactured according to the method of the invention.

The figures are entirely schematic and, for the purposes of clarity, are not to scale.

FIG. 1 depicts a portion of a stack of fabrics 1 of a forming fabric according to the invention. This stack of fabrics comprises a surface fabric 2 which is the outermost fabric of the stack of fabrics 1 directly in contact with the suspension of fibers and on which the fibrous ply 2 is formed.

Under the surface fabric 2 there are two under-fabrics 3, 4. The second under-fabric 4 has a lower linear wire density than the first under-fabric 3, which itself has a lower linear wire density than the surface fabric 2.

FIG. 2 depicts, in a simplified way, an under-fabric 3 of a stack of fabrics 1 according to the invention, said under-fabric being equipped with a region of reduced dewatering 5. The region of reduced dewatering 5 has a linear wire density that is greater than that of the remainder of the under-fabric 3, 4 which means that, in this region, as a fibrous ply forms, the fibrous suspension is dewatered more slowly than in the remainder of the under-fabric, and that, as a result, the amount of fibers deposited is lower than the amount of fibers deposited outside of this region.

FIG. 3 depicts, in a simplified way, another embodiment of a stack of fabrics 1 according to the invention, in which the region of reduced dewatering 5 of the under-fabric 3 is divided into several zones 13, 14 with different dewatering rates. The region of reduced dewatering 5 comprises a central zone 13 surrounded by two edge zones 14. The central zone 13 has a linear wire density higher than that of the edge zones 14 so that the dewatering rate and therefore the amount of fibers deposited in the central zone is lower than the dewatering rate in the edge zones 5. An arrangement such as this is particularly advantageous when the region of reduced dewatering is large.

FIG. 4 depicts a sectional view of a region of the surface fabric equipped with an embossed zone 6 intended to create a countersunk watermark 7 in a fibrous ply 8, 9. A greater quantity of fibers will build up in the countersunk zones.

FIG. 5 depicts a sectional view of a fibrous ply equipped with a watermark 7 manufactured, using the embossed surface fabric 2 of FIG. 4, according to the “conventional” method of the prior art, on a cylinder mold with a conventional forming fabric of a papermaking machine. The fibrous ply 8 thus obtained has increases in thickness Δe at the location of the watermark 7 corresponding to the countersunk embossed zones of the surface fabric 2.

FIG. 6 shows a sectional view of a fibrous ply 9 equipped with a watermark 7 obtained using the surface fabric 2 of FIG. 4, according to the method of the invention, the first under-fabric having a region of reduced dewatering in line with the embossed zone 6. The surface of the fibrous ply 9 thus obtained does not, unlike the fibrous ply 8 of FIG. 5, exhibit additional thicknesses. The watermark 7 is present but is situated in a nest created in the sheet by virtue of the zone of reduced dewatering, so that even though the watermark exhibits reliefs, these do not detract from the flatness of the ply 9.

FIG. 7 depicts a section view of a fibrous ply 10 equipped with a security thread 1.2 mm wide and 25 μm thick, manufactured on a cylinder mold using a “conventional” method of the prior art. The surface of the ply 10 thus obtained exhibits an increase in thickness at the security thread 11, because the amounts of fibers deposited at the security thread 11 and on the remainder of the ply 10 respectively are of the same order of magnitude.

FIG. 8 depicts a section view of a fibrous ply 12 equipped with the same security thread 11 as the one used in FIG. 7, but manufactured according to the method of the invention, the first under-fabric having a region of reduced dewatering over the entire periphery of the cylinder of the cylinder mold, said region having a width slightly greater than that of the thread, being about 1.5 mm. The surface of the sheet of paper 12 thus obtained does not exhibit any additional thickness due to the security thread 11, the thread 11 being included within the ply in the region of reduced dewatering. The security thread 11 is located in a nest created in the ply 12 by virtue of the region of reduced dewatering, such that the ply 12 is flat.

1. A method for using a wet process to manufacture a fibrous ply on a forming fabric of a papermaking machine comprising a stack of fabrics, said stack of fabrics comprising a surface fabric and at least one under-fabric, these being superposed, said fibrous ply comprising at least one element of a given thickness, wherein it comprises the following step:
forming said ply by dewatering a fiber-based aqueous suspension on said forming fabric, the stack of fabrics of which includes a region of reduced dewatering with respect to the dewatering of the first under-fabric, in at least one under-fabric and/or under the surface fabric, said region of reduced dewatering being in register with the position that said element will occupy.

2. The method of manufacturing a fibrous ply as claimed in claim 1, wherein the region of reduced dewatering has a dewatering rate equal to or lower than that of the surface fabric.

3. The method of manufacturing a fibrous ply as claimed in claim 1, wherein said element of a given thickness is formed in or incorporated into the ply while said ply is being formed on said forming fabric.

4. The method of manufacturing a fibrous ply as claimed in claim 1, wherein said element of a given thickness is attached to said ply after said ply has been formed.

5. The method of manufacturing a fibrous ply as claimed in claim 1, wherein said element of a given thickness has a thickness of between 10 μm and 60 μm.

6. The method of manufacturing a fibrous ply as claimed in claim 1, wherein said ply has a thickness of between 80 and 120 μm.

7. The method of manufacturing a fibrous ply as claimed in claim 1, wherein the fiber-based suspension comprises cellulose fibers.

8. The method of manufacturing a fibrous ply as claimed in claim 1, wherein said stack of fabrics is the forming fabric of the cylinder of a cylinder mold of a papermaking machine.

9. The method of manufacturing a fibrous ply as claimed in claim 1, wherein said stack of fabrics is the forming fabric of a fourdrinier of a papermaking machine.

10. The method of manufacturing a fibrous ply as claimed in claim 1, wherein the region of reduced dewatering has dimensions equal to or appreciably greater than those of said element of given thickness.

11. The method of manufacturing a fibrous ply as claimed in claim 1, wherein the surface fabric and the under-fabrics consist of interlaced wires forming meshes.

12. The method of manufacturing a fibrous ply as claimed in claim 11, wherein the region of reduced dewatering has a linear wire density equal to or greater than that of the surface fabric.

13. The method of manufacturing a fibrous ply as claimed in claim 1, wherein the surface fabric has embossings, facing the region of reduced dewatering.

14. The method of manufacturing a fibrous ply as claimed in claim 13, wherein the first under-fabric and/or the second under-fabric comprises an opening facing the embossings in the surface fabric.

15. The method of manufacturing a fibrous ply as claimed in claim 1, wherein the first under-fabric comprises an opening facing the position of said element of given thickness, and wherein a perforated piece of dimensions approximately equal to those of said opening and allowing reduced dewatering with respect to said under-fabric is attached under the surface fabric, at a position corresponding to said element.

16. The method of manufacturing a fibrous ply as claimed in claim 1, wherein the first under-fabric comprises an opening facing the position of said element of given thickness, and wherein a perforated piece of dimensions approximately equal to those of said opening and allowing reduced dewatering with respect to said under-fabric is fixed to the first under-fabric, in this opening, at a position corresponding to said element.

17. The method of manufacturing a fibrous ply as claimed in claim 15, wherein the surface fabric is embossed and wherein said perforated piece of dimensions approximately equal to those of said opening is embossed in exactly the same way as the embossings in said surface fabric.

18. The method of manufacturing a fibrous ply as claimed in claim 1, wherein at least one region of reduced dewatering is in discrete form.

19. The method of manufacturing a fibrous ply as claimed in claim 1, wherein at least one region of reduced dewatering has the shape of a continuous zone of given width extending along the entire length or along the entire width of said forming fabric.

20. The method of manufacturing a fibrous ply as claimed in claim 1, wherein the element of given thickness is a continuous strip at least partially included within said ply.

21. The method of manufacturing a fibrous ply as claimed in claim 20, further comprising a step whereby said continuous strip is incorporated into the zone facing said region of reduced dewatering while said fibrous ply is being formed on the forming fabric.

22. The method of manufacturing a fibrous ply as claimed in claim 20, wherein said strip is a security strip or thread with a width of between 1 and 30 mm.

23. The method of manufacturing a fibrous ply as claimed in claim 1, wherein said fibrous ply comprises a dark or countersunk watermark, said watermark being formed by embossings comprising countersunk embossed portions in the surface fabric, said embossings facing a region of reduced dewatering.

24. The method of manufacturing a fibrous ply as claimed in claim 1, wherein said region of reduced dewatering comprises several zones that have different dewatering rates.

25. The method of manufacturing a fibrous ply as claimed in claim 24, wherein said region of reduced dewatering comprises a central zone surrounded by at least two edge zones, said central zone and edge zones having different dewatering rates.

26. The method of manufacturing a fibrous ply as claimed in claim 25, wherein the central zone has a dewatering rate lower than the dewatering rates of the edge zones.

27. A forming fabric of a papermaking machine comprising a stack of fabrics comprising a surface fabric and at least one under-fabric, wherein at least one region of reduced dewatering with respect to the first under-fabric is situated in at least one under-fabric and/or attached under the surface fabric.

28. The forming fabric as claimed in claim 27, wherein the region of reduced dewatering has a dewatering rate equal to or lower than the dewatering rate of the surface fabric.

29. The forming fabric as claimed in claim 27, wherein the first under-fabric comprises a zone of reduced dewatering.

30. The forming fabric as claimed in claim 29, wherein all the regions of reduced dewatering are on the first under-fabric.

31. The forming fabric as claimed in claim 27, wherein the surface fabric comprises embossings facing the region of reduced dewatering.

32. The forming fabric as claimed in claim 31, wherein said region of reduced dewatering has embossings that are identical to the embossings of the surface fabric.

33. The forming fabric as claimed in claim 27, wherein the first under-fabric comprises an opening, and in that a perforated piece of dimensions approximately equal to those of said opening and which allow reduced dewatering with respect to said under-fabric, is attached under the surface fabric facing said opening.

34. The forming fabric as claimed in claim 27, wherein the first under-fabric comprises a perforated piece that allows reduced dewatering with respect to said under-fabric.

35. The forming fabric as claimed in claim 27, wherein the surface fabric and the under-fabrics consist of interlaced wires forming meshes.

36. The forming fabric as claimed in claim 35, wherein the region of reduced dewatering has a linear wire density equal to or greater than the linear wire density of the surface fabric.

37. The forming fabric as claimed in claim 27, wherein said region of reduced dewatering comprises several zones that have different dewatering rates.

38. The forming fabric as claimed in claim 37, wherein said region of reduced dewatering comprises a central zone surrounded by at least two edge zones, said central zone and edge zones having different dewatering rates.

39. The forming fabric as claimed in claim 38, wherein the central zone has a dewatering rate lower than the dewatering rates of the edge zones.

40. A method of manufacturing a forming fabric defined in claim 27, wherein a region of reduced dewatering is created by using a fragment of fabric or a perforated piece that allows the dewatering to be reduced with respect to the first under-fabric.

41. The method of manufacturing a forming fabric as claimed in claim 40, wherein the region of reduced dewatering is created by using a portion of a fabric that has a linear wire density higher than that of the first under-fabric.

42. The method of manufacturing a forming fabric as claimed in claim 40, wherein the region of reduced dewatering is created by using a portion of a fabric that has a wire density equal to or higher than that of the surface fabric.

43. The method of manufacturing a forming fabric as claimed in claim 40, wherein the region of reduced dewatering is situated in an under-fabric and is obtained by cutting away a fragment of said under-fabric and then in its place attaching a same-sized fragment of a fabric that has a wire density higher than the remainder of the under-fabric.

44. The method of manufacturing a forming fabric as claimed in claim 40, wherein said region of reduced dewatering is situated in an under-fabric and is obtained by attaching to said under-fabric a fragment of a fabric that has a linear wire density equal to or greater than that of the surface fabric.

45. The method of manufacturing a forming fabric as claimed in claim 40, wherein said region of reduced dewatering is a portion of fabric attached directly under the surface fabric.

46. The method of manufacturing a forming fabric as claimed in claim 40, wherein said region of reduced dewatering of the under-fabric is obtained by cutting away a fragment of said under-fabric and in its place attaching a perforated piece that allows reduced dewatering with respect to said under-fabric.

47. The method of manufacturing a forming fabric as claimed in claim 40, wherein said region of reduced dewatering is a perforated piece attached directly under the surface fabric.

48. The method of manufacturing a forming fabric as claimed in claim 46, wherein said perforated piece is made of metal or of plastic.

49. The method of manufacturing a forming fabric as claimed in claim 46, wherein said perforated piece is obtained by depositing a photosensitive resin on the surface fabric and insolating said resin using a perforated mask, the insolated portions of said resin being eliminated.

50. The method of manufacturing a forming fabric as claimed in claim 46, wherein said perforated piece is obtained by depositing a photosensitive resin on the surface fabric and insolating said resin using a perforated mask, the non-insolated portions of said resin being eliminated.

51. The method of manufacturing a forming fabric as claimed in claim 40, wherein the surface fabric is embossed and in that said bit of fabric or said perforated piece is embossed in exactly the same way as the embossings of the surface fabric.

52. A security sheet comprising at least one fibrous ply obtained by a method defined in claim 1.

53. A security document comprising a security sheet as claimed in claim 52.

54. The security document as claimed in claim 53, wherein said document is a means of payment such as a banknote or a check, an identity document such as an identity card or a passport, a travel ticket, an entry ticket to a cultural or sports event.

55. The method of manufacturing a fibrous ply as claimed in claim 1, wherein the thickness is between 20 and 40 μm.

56. The method of manufacturing a fibrous ply as claimed in claim 7, wherein the cellulose fibers are cotton fibers.

57. The method of manufacturing a fibrous ply as claimed in claim 13, wherein the embossing are countersunk embossings.

58. The method of manufacturing a fibrous ply as claimed in claim 22, wherein the width is between 1 and 10 mm.

59. The forming fabric as claimed in claim 31, wherein the embossings are countersunk embossings.
